(19) United States
(12) Patent Application Publication
(10) Pub. No.: US 2019/0370321 A1
(43) Pub. Date: Dec. 5, 2019

(54) SYSTEMS AND METHODS FOR SECURE AND INTERACTIVE LAYER BASED PRESENTATION OF SPREADSHEET SECTIONS

(71) Applicant: Gianluca Bisceglie, Matera (IT)

(72) Inventor: Gianluca Bisceglie, Matera (IT)

(21) Appl. No.: 16/425,974

(22) Filed: May 30, 2019

Related U.S. Application Data
(60) Provisional application No. 62/679,039, filed on Jun. 1, 2018.

(51) Int. Cl. G06F 17/24; G06F 16/176; G06F 16/958

(52) U.S. Cl. CPC G06F 17/246; G06F 16/958; G06F 16/176

(57) ABSTRACT

Embodiments of the present disclosure provides methods and spreadsheet managing systems for presenting designated spreadsheet sections of a spreadsheet through a web interface without exposing other spreadsheet sections across a network service. The methods and systems provide a secure layer-based presentation of spreadsheet sections for visualization and manipulation of data in designated spreadsheet sections to derive output from calculations based on data from other spreadsheet sections without exposing or altering other spreadsheet sections. A first user can share a resource locator with second user(s) along with one or more permissions for accessing the designated spreadsheet sections. The second user(s) can manipulate the designated spreadsheet sections to get an output based on the data and calculations in the designated spreadsheet sections. Calculation output requested to the central spreadsheet engine or system may not modify it and only appear in the virtual layers from which the calculation request has been made.

### TECHNICAL FIELD

The presently disclosed embodiments relate to the field of spreadsheet applications. More specifically, embodiments of the present disclosure relate to secure and selective network-based presentation of and interaction with spreadsheet sections.

### BACKGROUND

Documents, including spreadsheets, have limitations in terms of how the underlying data in the spreadsheet is shared and interacted with. Typically, a spreadsheet, is shared by: copying files containing the worksheets (spreadsheets), and providing a copy of the file to each person with whom the author wants to share the data. Sharing is done at the file level of granularity and each user works on a copy of the file. When a shared user modifies a copy of the workbook, the change exists only in that user's version of the workbook. Every user is granted complete access to and can view and/or modify their copy of the workbook. However, this is inconvenient as one user's changes are not available to the other users, so sharing involves sending updated copies around to each of the users and manually tracking the latest one, with inevitable errors and data chaos.

Presently, some spreadsheet applications allow granting of access of a single workbook to multiple users. They enable each user that is granted access to view and/or modify essentially the same workbook. Further, this enables all users to see each other's updates when, in most cases, users want to test assumptions and changes privately and never expose them to the other users or, worse, change the default numbers the model owner put in. Web-based spreadsheet avoids email back and forth but introduces a “last input win” problem whereby the last editor of a cell or chart will leave their mark until the next one changes it. In some cases, sharing can be granted at the worksheet level, so that different users are granted permissions to view and/or modify a sheet of the workbook (e.g., a page of the workbook) instead of the entire workbook. However, in these cases, the users granted with access to the workbook or sheets are still granted with viewing and/or modifying permission for the entire workbook or sheet. In other words, in the event that a workbook is shared, then the entire workbook is viewable, and in the event that a worksheet is shared, then the entire worksheet is viewable. Any information (e.g., a cell, a table, a chart, etc.) that should not be available for viewing and/or modifying by a specific user cannot be placed in the workbook or sheet, which is often impractical and inconvenient: the file owner must create separate sanitized copies with missing information and trigger the chaos of versions (growing exponentially with the number of collaborators or users) going back and forth via email or other sharing platforms.

Therefore, to overcome these issues there is a need for secure and selective presentation and manipulation tool that provides a virtual presentation and manipulation layer of a designated spreadsheet content that can be presented in a web-based environment thereby restricting access to parts or sections of the original workbook or worksheet and eliminating the need for an end user to download the entire workbook or worksheet on their computing devices, make changes and send it back to all collaborators; or, in the case of web-based spreadsheets (like Google sheets), that prevents collaborators from destroying what others entered before them, letting all collaborators co-exist and interact with only what they put in or what others want them to see and interact with.

### SUMMARY

In light of the above, there exists a need for providing a method and system for presentation of one or more designated spreadsheet sections contained within a spreadsheet and grant of permission to interact with the one or more designated spreadsheet sections through a web interface without exposing other spreadsheet sections across a network service.

The present disclosure provides a method and a system for presenting and/or granting interaction with one or more designated spreadsheet sections in at least one of an editable or non-editable virtual layer in a web browser without exposing other spreadsheet sections to one or more second users connected through a network. Further, the one or more second users in the network can manipulate the data in the designated spreadsheet section to determine a resultant output based on the data present in other sections of the spreadsheet in the form of calculations, charts, graphs, or the like without altering any section of the spreadsheet.

An embodiment of the present disclosure provides a method for enabling a first user to selectively present and/or grant interaction with one or more sections of a spreadsheet to one or more second users connected to a network. The method includes receiving a selection of one or more designated spreadsheet sections of the spreadsheet from the first user. The method further includes providing a plurality of permission options to the first user. The first user allocates at least one permission to the one or more second users for initiating a session for interaction with the one or more designated spreadsheet sections by selecting one or more of the plurality of permission options. The method furthermore includes providing a resource locator to the one or more second users to enable the one or more second users to initiate the session for interaction with the one or more designated spreadsheet sections via the resource locator based on the at least one permission. The method also includes enabling the one or more second users to manipulate data of the one or more designated spreadsheet sections to obtain an output based on the data and calculations available on the one or more designated spreadsheet sections.

According to an aspect of the present disclosure, the calculation results obtained by interacting with the designated spreadsheet sections via web-layers are only visible to the user requesting those calculations.

According to another aspect of the present disclosure, the calculation output requested to the spreadsheet managing system may not modify the spreadsheet and only appear in the virtual layer of the second user from which the calculation request has been made.

According to another aspect of the present disclosure, the method includes determining the output when the one or more second users with the allocated permissions manipulates the data in the designated spreadsheet sections based on the data present in other sections of the spreadsheet in the form of calculations, charts, and graphs without altering any other section of the spreadsheet. Further, the manipulations done to the one or more spreadsheet sections remain in the virtual layer and not transferred to the spreadsheet.

According to another aspect of the present disclosure, the one or more designated spreadsheet sections are presented to the one or more second users on initiation of the session for interaction such that other spreadsheet sections are not visible to the one or more second users, wherein the one or more designated spreadsheet sections are displayed via at least one of an editable virtual layer and a non-editable virtual layer in a web browser on an associated second computing device of the one or more second users.

According to another aspect of the present disclosure, the method further includes enabling the one or more second users to save one or more changes done in the one or more designated spreadsheet sections comprising edited virtual layers at one or more second users' end respectively based on the at least one permission.

According to another aspect of the present disclosure, the method further includes associating the one or more designated spreadsheet sections with at least one uniform resource locator (URL) to be used to display a virtual layer in the web browser.

According to another aspect of the present disclosure, the method further includes determining the output when the one or more second users with the allocated permissions manipulates the data in the designated spreadsheet sections based on the data present in other sections of the spreadsheet in the form of calculations, charts, and graphs without altering any other section of the spreadsheet.

Another embodiment of the present disclosure provides a spreadsheet managing system for enabling a first user to selectively present and/or grant interaction with one or more sections of a spreadsheet to one or more second users connected to a network. The spreadsheet managing system includes an input module configured to receive a selection of one or more designated spreadsheet sections of the spreadsheet from the first user. The spreadsheet managing system also includes a permission managing module configured to provide a plurality of permission options to the first user, wherein the first user allocates at least one permission to the one or more second users for initiating a session for interaction with the one or more designated spreadsheet sections by selecting one or more of the plurality of permission options. The spreadsheet managing system also includes a processing module configured to provide a resource locator to the one or more second users to enable the one or more second users to initiate the session for interaction with the one or more designated spreadsheet sections via the resource locator based on the at least one permission. The processing module is also configured to enable the one or more second users to manipulate data of the one or more designated spreadsheet sections to obtain an output based on the data and calculations available on the one or more designated spreadsheet sections.

According to an aspect of the present disclosure, the one or more designated spreadsheet sections comprises one or more sections selected from at least one of a chart, a graph, and at least one cell of the spreadsheet.

According to another aspect of the present disclosure, the spreadsheet managing system includes a display module configured to present the one or more designated spreadsheet sections to the one or more second users on initiation of the session for interaction such that other spreadsheet sections are not visible to the one or more second users, wherein the one or more designated spreadsheet sections are displayed via at least one of an editable virtual layer and a non-editable virtual layer in a web browser on an associated second computing device of the one or more second users.

According to another aspect of the present disclosure, the processing module is further configured to enable the one or more second users to save one or more changes done in the one or more designated spreadsheet sections comprising edited virtual layers at one or more second users' end respectively based on at least one permission.

According to another aspect of the present disclosure, the processing module is further configured to associate the one or more designated spreadsheet sections with at least one uniform resource locator (URL) to be used to display a virtual layer in the web browser.

According to another aspect of the present disclosure, the processing module is further configured to determine the output when the one or more second users with the allocated permissions manipulates the data in the designated spreadsheet sections based on the data present in other sections of the spreadsheet in the form of calculations, charts, and graphs without altering any other section of the spreadsheet. Further, the manipulations done to the one or more spreadsheet sections remain in the virtual layer and not transferred to the spreadsheet.

Yet another embodiment of the present disclosure provides a method for presenting and/or granting interaction with at least one spreadsheet section contained within a spreadsheet through a web interface without exposing other spreadsheet sections. The method includes enabling, by an input module of a spreadsheet managing system, a first user to select and prepare one or more designated spreadsheet sections from the spreadsheet for sharing with one or more second users connected to a network via a virtual layer. The one or more designated spreadsheet sections comprise one or more sections selected from at least one of a chart, a graph, and at least one cell of the spreadsheet. The method also includes providing, by a permission managing module of the spreadsheet managing system, a plurality of permission options to the first user, wherein the first user allocates at least one permission to the one or more second users for initiating a session for interaction with the one or more designated spreadsheet sections by selecting one or more of the plurality of permission options. The method also includes associating, by the processing module, the one or more designated spreadsheet sections with at least one uniform resource locator (URL) to be used to display a virtual layer in a web browser. The method also includes providing, by the processing module, at least one uniform resource locator to the one or more second users to enable the one or more second users to initiate the session for interaction with the one or more designated spreadsheet sections based on the at least one permission. The method also includes presenting, by a display module of the spreadsheet managing system, the one or more designated spreadsheet sections to the one or more second users on initiation of the session for interaction such that other spreadsheet sections are not visible to the one or more second users, wherein the one or more designated spreadsheet sections are displayed via at least one of an editable virtual layer and a non-editable virtual layer in the web browser on an associated second computing device of the one or more second users. The method further includes enabling, by the processing module, the one or more second users to manipulate data of the one or more designated spreadsheet sections to obtain an output based on the data and calculations available on the one or more designated spreadsheet sections. The calculation output requested to the spreadsheet managing system may not modify the spreadsheet and only appear in the virtual layers from which the calculation request has been made.

According to an aspect of the present disclosure, the first user is an administrator of the spreadsheet and the one or more designated spreadsheet sections.

According to an aspect of the present disclosure, the spreadsheet is present in a cloud network.

According to another aspect of the present disclosure, the at least one permission allocated to the one or more second users comprises a permission for supplementary allocation of one or more permissions to at least one user.

According to another aspect of the present disclosure, at least one of the one or more second users having special editing permission allocated by the first user is allowed to modify the content of the one or more designated spreadsheet sections, wherein the display module presents the one or more designated spreadsheet sections comprising modified content in a single view to at least one of the first user and other second users.

According to an aspect of the present disclosure, the output is determined when the one or more second users with the allocated permissions manipulates the data in the designated spreadsheet sections based on the data present in other sections of the spreadsheet in the form of calculations, charts, and graphs without altering any other section of the spreadsheet.

### BRIEF DESCRIPTION OF THE DRAWINGS

The foregoing summary, as well as the following detailed description of various embodiments, is better understood when read in conjunction with the drawings provided herein. For the purposes of illustration, there is shown in the drawings exemplary embodiments. However, the presently disclosed subject matter is not limited to the specific methods and instrumentalities disclosed.

FIG. 1 illustrates an exemplary environment where various embodiments of the present disclosure may function;

FIG. 2 is a block diagram illustrating system elements of a spreadsheet managing system, in accordance with an embodiment of the present disclosure;

FIG. 3 is a flowchart illustrating a method for enabling a first user to selectively present one or more sections of a spreadsheet to one or more second users connected to a network via a virtual layer, in accordance with an embodiment of the present disclosure; and

FIGS. 4A-4B is a flowchart illustrating a method for presenting at least one spreadsheet section contained within a spreadsheet through a web interface without exposing other spreadsheet sections, in accordance with an embodiment of the present disclosure.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Reference throughout this specification to “a select embodiment”, “one embodiment” or “an embodiment” means that a particular feature, structure, or characteristic described in connection with the embodiment is included in at least one embodiment of the disclosed subject matter. Thus, the appearance of the phrases “a select embodiment” “in one embodiment” or “in an embodiment” in various places throughout this specification is not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

As used in this specification and the appended claims, the singular forms “a,” “an,” and “the” include or otherwise refer to singular as well as plural referents, unless the content clearly dictates otherwise. As used in this specification and the appended claims, the term “or” is generally employed to include “and/or,” unless the content clearly dictates otherwise.

As used in this specification and the appended claims, a module refers to a device, system or a hardware configured to perform one or more functions or instructions according to the method disclosed in the present disclosure. The module can be a single device or multiple devices configured to perform one or more functions or instructions according to the method disclosed in the present disclosure.

The embodiments used herein are for organizational purposes only and are not meant to be used to limit the scope of the description or the claims. As used throughout this application, the word “may” is used in a permissive sense (i.e., meaning having the potential to), rather than the mandatory sense (i.e., meaning must).

In accordance with the exemplary embodiments, the disclosed computer programs or modules can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs or files over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. The network may include multiple networks or sub networks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Examples of the network include, but are not limited to, a personal area network (PAN), a storage area network (SAN), a home area network (HAN), a campus area network (CAN), a local area network (LAN), a wide area network (WAN), a metropolitan area network (MAN), a virtual private network (VPN), an enterprise private network (EPN), Internet, a global area network (GAN), and so forth.

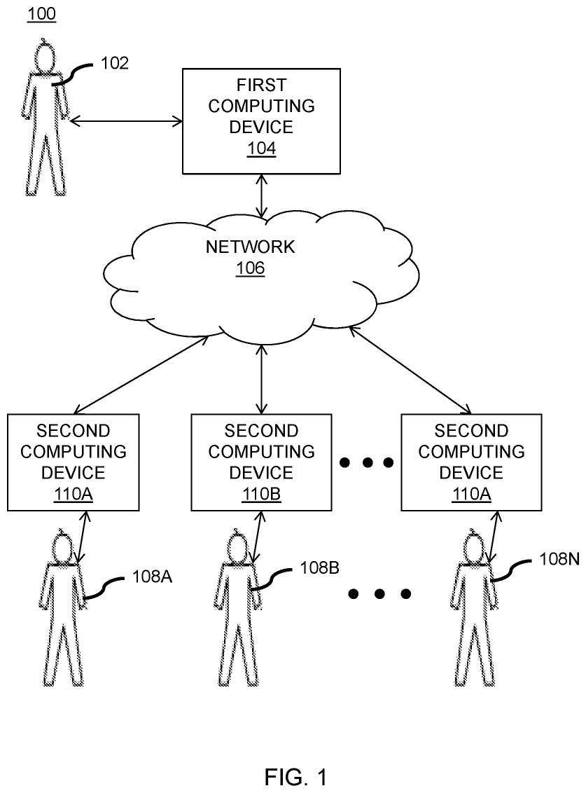

FIG. 1 illustrates an exemplary environment 100 where various embodiments of the present disclosure may function. The environment 100 primarily includes a plurality of users comprising a first user 102 having an associated first computing device 104 and one or more second users 108A-108N each having an associated second computing device of the second computing devices 110A-110N, respectively. The first user 102 and the one or more other second users 108A-108N are connected to a network 106. The one or more other second users 108A-108N are connected to a network 106 via a virtual layer The first computing device 104 and the one or more second computing devices 110A-110N are connected through the network 106. Examples of the first computing device 104 and the second computing devices 110A-110N includes, but are not limited to, a mobile phone, a computer, a laptop, a tablet computer, a smart watch, and so forth.

The first user 102 is an administrator of a spreadsheet stored in a cloud network, and one or more designated spreadsheet sections of the spreadsheet. The first user 102 can share at least one spreadsheet section contained within a spreadsheet through a web interface without exposing other spreadsheet sections with the one or more second users 108A-108N by using a spreadsheet managing system. The web interface may include a web browser on the first computing device 104 and a web server. The web server may be located in the network 106 or a cloud network. Further, the spreadsheet managing system enables the first user 102 to selectively present one or more sections of a spreadsheet to the one or more second users 108A-108N connected to the network 106.

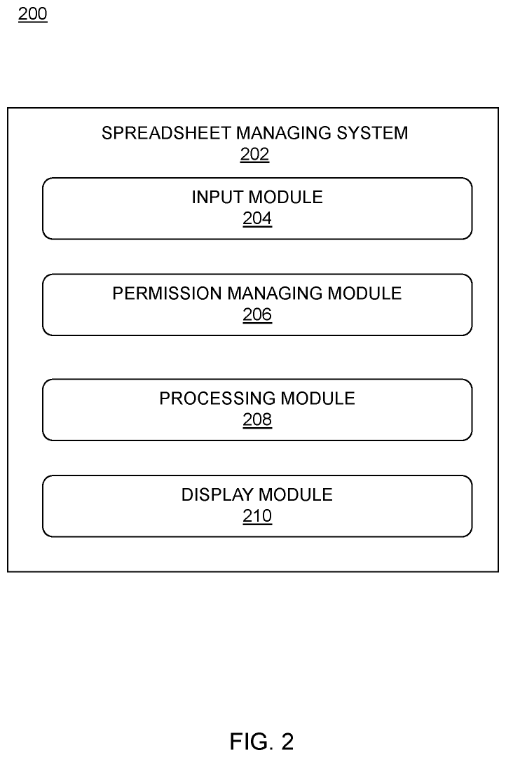

In some embodiments, the spreadsheet managing system (described in detail with reference to FIG. 2) is present in the first computing device 104. In alternative embodiments, the spreadsheet managing system is present in a network device such as, but not limited to, a server in the network 106. In some embodiments, the network 106 includes a central spreadsheet engine or server. The spreadsheet managing system may interact with the central spreadsheet engine or server.

The spreadsheet managing system may receive a selection of one or more designated spreadsheet sections of a spreadsheet from the first user 102. In some embodiments, the spreadsheet is located in a cloud network. The one or more designated spreadsheet sections may include one or more sections selected from at least one of a chart, a graph, at least one cell, and the like of the spreadsheet. In some embodiments, the spreadsheet managing system enables the first user 102 to select and prepare one or more designated spreadsheet sections from the spreadsheet stored in the cloud network for sharing with one or more second users 108A-108N connected to the network 106 via a virtual layer.

The spreadsheet managing system provides a number of permission options to the first user 102. The first user 102 allocates at least one permission to the one or more second users 108A-108N for initiating a session for interaction with the one or more designated spreadsheet sections by selecting one or more of the plurality of permission options. The at least one permission allocated to the one or more second users 108A-108N may include a permission for supplementary allocation of one or more permissions to at least one user. Examples of the at least one permission may include but are not limited to, a viewing permission, an editing permission, a sharing permission, a saving permission, and so forth.

Further, the first user 102 may allocate different permission to the different second users 108A-108B. For example, the user 108A can see only worksheet 1, user 108B can see and add his scenarios (and/or assumptions) to only worksheet 2, user 108B can only see a web-based slide with a chart and dropdown input connected to an input cell of the spreadsheet to test results, etc.

Further, the spreadsheet managing system provides a resource locator to the one or more second users 108A-108N to enable the one or more second users 108A-108N to initiate the session for interaction with the one or more designated spreadsheet sections via the resource locator based on the at least one permission. The resource locator may include a link to a storage location, a uniform resource locator to a web page, an address of a network device, an address of a cloud based network storing the one or more designated spreadsheet sections. In some embodiments, the spreadsheet managing system associates the one or more designated spreadsheet sections with at least one uniform resource locator (URL) to be used to display a virtual layer in the web browser. Examples of the web browser may include Microsoft Internet Explorer, Apple Safari, Google Chrome, Opera, Mozilla Firefox, Lynx, and so forth.

In some embodiments, the spreadsheet managing system presents the one or more designated spreadsheet sections to the one or more second users 108A-108N on initiation of the session for interaction such that other spreadsheet sections are not visible to the one or more second users 108A-108N. The one or more designated spreadsheet sections are displayed via at least one of an editable virtual layer and a non-editable virtual layer in a web browser on an associated second computing device i.e. the respective second computing devices 110A-110N of the one or more second users 108A-108N. In some embodiments, the one or more designated spreadsheet sections are displayed via the editable virtual layer when the at least one permission allocated to the one or more second users 108A-108N includes an editing permission. In some embodiments, the one or more designated spreadsheet sections are displayed via the editable virtual layer is displayed when the at least one permission allocated to the one or more second users 108A-108N includes only a view permission and no editing permission.

The spreadsheet managing system also enables the one or more second users 108A-108N to manipulate data of the one or more designated spreadsheet sections to obtain an output based on the data and calculations available on the one or more designated spreadsheet sections. In some embodiments, the spreadsheet managing system determines the output when the one or more second users 108A-108N with the allocated permissions manipulates the data in the designated spreadsheet sections based on the data present in other sections of the spreadsheet in the form of calculations, charts, and graphs without altering any other section of the spreadsheet.

Further, at least one of the one or more second users 108A-108N having special editing permission allocated by the first user 102 is allowed to modify the content of the one or more designated spreadsheet sections. In some embodiments, the spreadsheet managing system presents the one or more designated spreadsheet sections comprising modified content in a single view to at least one of the first user 102 and other second users 108A-108N based on the allocated at least one permission. In some embodiments, the manipulations or modifications done in the one or more spreadsheet sections remain in the virtual layer and not transferred to the spreadsheet.

The spreadsheet managing system also enables the one or more second users 108A-108N to save one or more changes done in the one or more designated spreadsheet sections including edited virtual layers at one or more second users' end respectively based on the at least one permission. The one or more second users' end may include a storage location of the second computing devices 110A-110N, respectively. In some embodiments, the one or more second users 108A-108N are allowed to save a copy of the one or more designated sections (edited or unedited) at their end.

In some embodiments, the first user 102 is allowed to undo one or more changes done by the one or more second users 108A-108N on the one or more designated spreadsheet sections.

In some embodiments, the calculation output requested to the spreadsheet managing system or a central spreadsheet engine do not modify the spreadsheet or the spreadsheet sections, and the changes or manipulation may only appear in the virtual layers from which the calculation request has been made.

FIG. 2 is a block diagram 200 illustrating system elements of a spreadsheet managing system 202, in accordance with an embodiment of the present disclosure. As shown, the spreadsheet managing system 202 includes an input module 204, a permission managing module 206, a processing module 208, and a display module 210. As discussed with reference to the FIG. 1, the spreadsheet managing system 202 may be present in the first computing device 104. Alternatively, the spreadsheet managing system 202 may be present in a network device such as, but not limited to, a server in the network 106.

The first user 102 may be an administrator of the spreadsheet and the one or more designated spreadsheet sections. The first user 102 can share at least one spreadsheet section contained within a spreadsheet through a web interface without exposing other spreadsheet sections with the one or more second users 108A-108N by using the spreadsheet managing system 202. The web interface may include a web browser on the first computing device 104 and a web server. The web server may be located in the network 106 or a cloud network. Further, the spreadsheet managing system 202 enables the first user 102 to selectively present one or more sections of a spreadsheet to the one or more second users 108A-108N connected to the network 106.

The input module 204 is configured to receive a selection of one or more designated spreadsheet sections of a spreadsheet from the first user 102. The spreadsheet may be stored in a cloud network. The one or more designated spreadsheet sections may include one or more sections selected from at least one of a chart, a graph, at least one cell, and so forth of the spreadsheet.

In some embodiments, the input module 204 enables the first user 102 to select and prepare one or more designated spreadsheet sections from the spreadsheet stored in the cloud network for sharing with one or more second users 108A-108N connected to the network 106.

The permission managing module 206 is configured to provide a plurality of permission options to the first user 102. The first user 102 allocates at least one permission to the one or more second users 108A-108N for initiating a session for interaction with the one or more designated spreadsheet sections by selecting one or more of the plurality of permission options. Examples of the at least one permission may include but are not limited to, a viewing permission, an editing permission, a sharing permission, a saving permission, and so forth. In some embodiments, the at least one permission allocated to the one or more second users 108A-108N includes a permission for supplementary allocation or further allocation of one or more permissions to at least one user like other second users or a third user.

Further, the first user 102 may allocate different permission to the different second users 108A-108B. For example, the user 108A can see only worksheet 1, user 108B can see and add his scenarios (and/or assumptions) to only worksheet 2, user 108B can only see a web-based slide with a chart and dropdown input connected to an input cell of the spreadsheet to test results, etc.

In some embodiments, the first user 102 may allocate different permission for accessing the one or more designated spreadsheet sections to different users of the second users 108A-108N. For example, the first user 102 may allocate a viewing permission to the second user 108A and a viewing and an editing permission to the second user 108B. Similarly, a viewing and sharing permission to the second user 108C.

The processing module 208 is configured to provide a resource locator to the one or more second users 108A-108N to enable the one or more second users 108A-108N to initiate the session for interaction with the one or more designated spreadsheet sections via the resource locator based on the at least one permission. The resource locator may include a link to a storage location, a uniform resource locator to a web page, an address of a network device, an address of a cloud based network storing the one or more designated spreadsheet sections.

Further, the processing module 208 is configured to associate the one or more designated spreadsheet sections with at least one uniform resource locator (URL) to be used to display a virtual layer in a web browser. Examples of the web browser may include Microsoft Internet Explorer, Apple Safari, Google Chrome, Opera, Mozilla Firefox, Lynx, and so forth.

The display module 210 is configured to present the one or more designated spreadsheet sections to the one or more second users 108A-108N on initiation of the session for interaction such that other spreadsheet sections are not visible to the one or more second users 108A-108N. The session for interaction may be initiated based on the selection of the resource locator by the one or more of the second users 108A-108N. The one or more designated spreadsheet sections may be displayed on the second computing devices 110A-110N of the second users 108A-108N, respectively based on the at least one permission allocated to the one or more second users 108A-108N. The one or more designated spreadsheet sections are displayed via at least one of an editable virtual layer and a non-editable virtual layer in the web browser on an associated second computing device of the one or more second users.

In some embodiments, the one or more designated spreadsheet sections are displayed via the editable virtual layer when the at least one permission allocated to the one or more second users 108A-108N includes an editing permission. In some embodiments, the one or more designated spreadsheet sections are displayed via the editable virtual layer when the at least one permission allocated to the one or more second users 108A-108N includes only a view permission and no editing permission.

Further, the processing module 208 is configured to enable the one or more second users 108A-108N to manipulate data of the one or more designated spreadsheet sections to obtain an output based on the data and calculations available on the one or more designated spreadsheet sections. In some embodiments, the processing module 208 is further configured to determine the output when the one or more second users 108A-108N with the allocated permissions manipulates the data in the one or more designated spreadsheet sections based on the data present in other sections of the spreadsheet in the form of calculations, charts, number, graphs, and so forth without altering any other section(s) of the spreadsheet. In some embodiments, the manipulations or modifications done in the one or more spreadsheet sections remain in the virtual layer and not transferred to the spreadsheet (or the central spreadsheet engine).

In some embodiments, the processing module 208 is further configured to enable the one or more second users 108A-108N to save one or more changes done in the one or more designated spreadsheet sections including edited virtual layers at one or more second users' end respectively based on the at least one permission. In some embodiments, the one or more changes are visible only to the users themselves not to everyone, unless they have the permission to collaborate on the spreadsheet directly, hence adding assumptions and scenarios in the central spreadsheet engine or in the spreadsheet managing system 202. The central spreadsheet engine may be a spreadsheet managing system or device centrally located in a network or cloud network. The one or more second users' end may include a storage location of the second computing devices 110A-110N, respectively. In some embodiments, the one or more second users 108A-108N are allowed to save a copy of the one or more designated sections (edited or unedited) at their end.

In some embodiments, at least one of the one or more second users 108A-108N having special editing permission allocated by the first user 102 is allowed to modify the content of the one or more designated spreadsheet sections. In some embodiments, the manipulations or modifications done in the one or more spreadsheet sections remain in the virtual layer and not transferred to the spreadsheet (or the central spreadsheet engine).

The display module 210 may be configured to present the one or more designated spreadsheet sections including modified content in a single view to at least one of the first user 102 and other second users 108A-108N.

According to an aspect of the present disclosure, the calculation results obtained by interacting with the designated spreadsheet sections via web-layers are only visible to the user requesting those calculations.

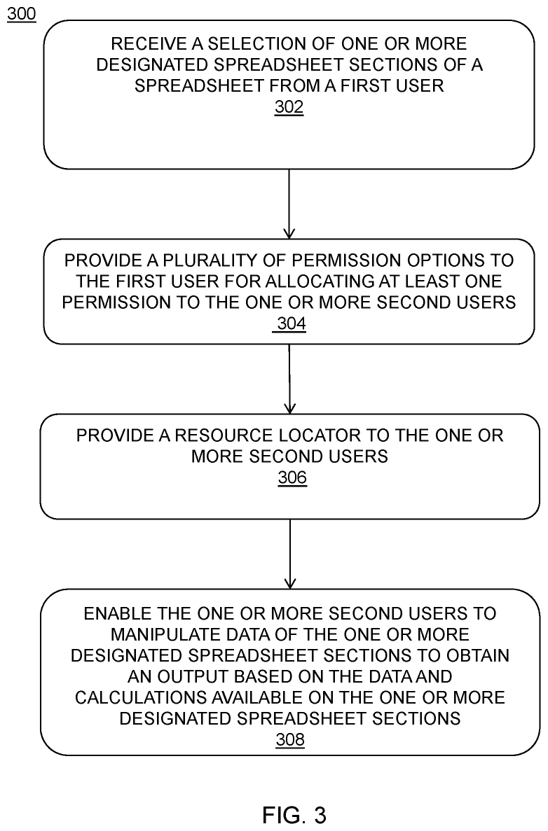

FIG. 3 is a flowchart illustrating a method 300 for enabling a first user to selectively present one or more sections of a spreadsheet to one or more second users connected to a network, in accordance with an embodiment of the present disclosure. As discussed with reference to the FIG. 1, the first user may be the first user 102 and the one or more second users may be the one or more second users 108A-108N. The first user 102 may be an administrator of the spreadsheet and the one or more designated spreadsheet sections. The first user 102 can share at least one spreadsheet section contained within a spreadsheet through a web interface without exposing other spreadsheet sections with the one or more second users 108A-108N by using the spreadsheet managing system 202. The web interface may include a web browser on the first computing device 104 and a web server. The web server may be located in the network 106 or a cloud network. Further, the spreadsheet managing system 202 enables the first user 102 to selectively present one or more sections of a spreadsheet to the one or more second users 108A-108N connected to the network 106.

Further, as discussed with reference to the FIG. 2 the spreadsheet managing system 202 includes the input module 204, the permission managing module 206, the processing module 208, and the display module 210. In some embodiments, the spreadsheet managing system 202 may be present in the first computing device 104. Alternatively, the spreadsheet managing system 202 may be present in a network device such as, but not limited to, a server in the network 106. The spreadsheet managing system 202 may be a central spreadsheet managing system or engine. In some embodiments, the spreadsheet managing system 202 may interact with a central spreadsheet engine located on a remote location in the network 106.

The method initiates at step 302. At step 302, the input module 204 receives a selection of one or more designated spreadsheet sections of a spreadsheet from the first user 102. The spreadsheet may be stored in the cloud network and the first user selects the one or more designated spreadsheet sections of the spreadsheet on the first computing device 104. The one or more designated spreadsheet sections may include one or more sections selected from at least one of a chart, a graph, at least one cell, and so forth of the spreadsheet.

Then at step 304, the permission managing module 206 provides a plurality of permission options to the first user 102 for allocating at least one permission to the one or more second users 108A-108N. The first user 102 allocates at least one permission to the one or more second users 108A-108N for initiating a session for interaction with the one or more designated spreadsheet sections by selecting one or more of the plurality of permission options. Examples of the at least one permission may include but are not limited to, a viewing permission, an editing permission, a sharing permission, a saving permission, and so forth. In some embodiments, the at least one permission allocated to the one or more second users 108A-108N includes a permission for supplementary allocation or further allocation of one or more permissions to at least one user like other second users or a third user.

Then at step 306, the processing module 208 provides a resource locator to the one or more second users 108A-108N to enable the one or more second users 108A-108N to initiate the session for interaction with the one or more designated spreadsheet sections via the resource locator based on the at least one permission. The resource locator may include a link to a storage location, a uniform resource locator to a web page, an address of a network device, an address of a cloud based network storing the one or more designated spreadsheet sections.

Thereafter at step 308, the processing module 208 enables the one or more second users to manipulate data of the one or more designated spreadsheet sections to obtain an output based on the data and calculations available on the one or more designated spreadsheet sections. In some embodiments, the processing module 208 is further configured to determine the output when the one or more second users 108A-108N with the allocated permissions manipulates the data in the one or more designated spreadsheet sections based on the data present in other sections of the spreadsheet in the form of calculations, charts, and graphs without altering any other section(s) of the spreadsheet.

In an exemplary scenario, a user A can share one or more designated section including graphs from a spreadsheet with a user B with a viewing permission. Similarly, the user A can share one or more designated sections including numbers and data from a spreadsheet with a user C with a viewing and sharing permission and with user D with viewing, editing, sharing permission. The user A can share different or same sections of the spreadsheet with different users i.e. the user B, the user C, and the user D, and may allocate different permissions for accessing the different sections. The user B can view only the sections of the spreadsheet that includes the graphs. The user C can view the sections of the spreadsheet including the numbers and data and is also allowed to share the same sections with other users. The user D can also view the sections of the spreadsheet including the numbers and data and is allowed to share the same sections with other users. In addition, the user D is allowed to add layers of assumptions and scenarios for editing the sections including the numbers and the data. Further, editing can be done either at the central spreadsheet engine level i.e. the spreadsheet managing system (although the user D can add layers of assumptions or scenarios) for everyone to see, or within his (user D's) contained virtual web layer where his changes can be seen and presented only by the users allowed to see that layer.

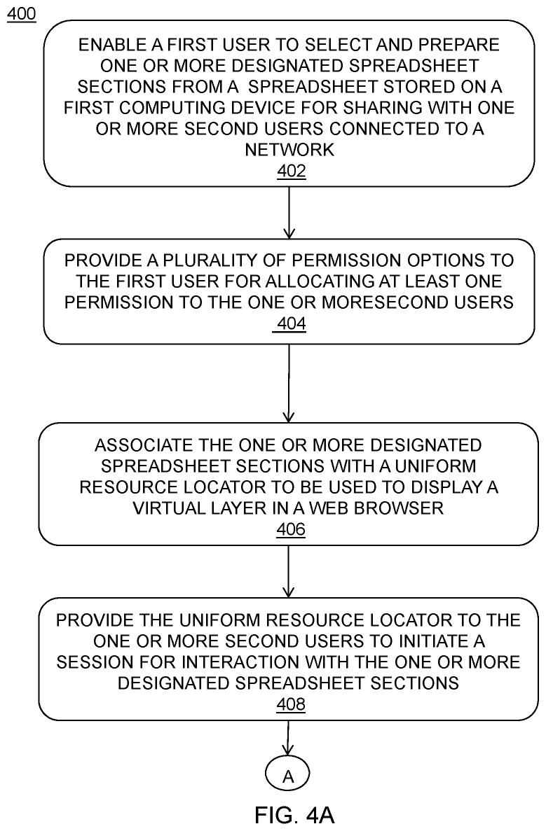

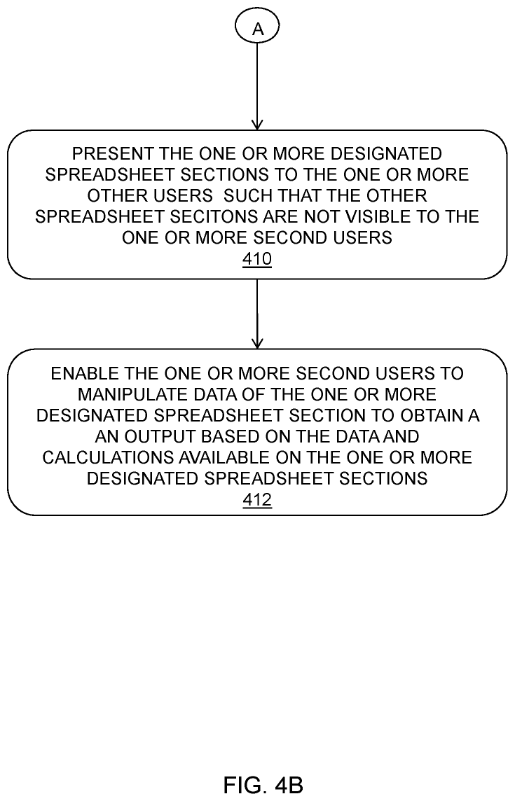

FIGS. 4A-4B is a flowchart illustrating a method 400 for presenting at least one spreadsheet section contained within a spreadsheet through a web interface without exposing other spreadsheet sections, in accordance with an embodiment of the present disclosure. As discussed with reference to the FIG. 1, the first user may be the first user 102 and the one or more second users may be the one or more second users 108A-108N. The first user 102 may be an administrator of the spreadsheet and the one or more designated spreadsheet sections. The first user 102 can share at least one spreadsheet section contained within a spreadsheet through a web interface without exposing other spreadsheet sections with the one or more second users 108A-108N by using the spreadsheet managing system 202. The web interface may include a web browser on the first computing device 104 and a web server. The web server may be located in the network 106 or a cloud network. Further, the spreadsheet managing system 202 enables the first user 102 to selectively present one or more sections of a spreadsheet to the one or more second users 108A-108N connected to the network 106.

Further, as discussed with reference to the FIG. 2 the spreadsheet managing system 202 includes the input module 204, the permission managing module 206, the processing module 208, and the display module 210. In some embodiments, the spreadsheet managing system 202 may be present in the first computing device 104. Alternatively, the spreadsheet managing system 202 may be present in a network device such as, but not limited to, a server in the network 106.

The method 400 initiates at step 402. At step 402, the input module 204 enables the first user 102 to select and prepare one or more designated spreadsheet sections from a spreadsheet stored in a cloud network for sharing with the one or more second users 108A-108N connected to the network 106. The one or more designated spreadsheet sections may include one or more sections selected from at least one of a chart, a graph, at least one cell, and so forth of the spreadsheet. According to one aspect of the present disclosure, preparing the designated spreadsheet sections means selecting a set of specific spreadsheet section, which can be one or more cells, a graph, a chart or any other similar section which a user designates to be presented across the network 106.

At step 404, the permission managing module 206 provides a number of permission options to the first user 102 for allocating at least one permission to the one or more second users 108A-108N. The first user 102 allocates at least one permission to the one or more second users 108A-108N for initiating a session for interaction with the one or more designated spreadsheet sections by selecting one or more of the plurality of permission options. Examples of the at least one permission may include but are not limited to, a viewing permission, an editing permission, a sharing permission, a saving permission, and so forth. In some embodiments, the at least one permission allocated to the one or more second users 108A-108N includes a permission for supplementary allocation or further allocation of one or more permissions to at least one user like other second users or a third user.

Then at step 406, the processing module 208 associates the one or more designation spreadsheet sections with a resource locator, such as a uniform resource locator (URL), to be used to display a virtual layer in a web browser. Examples of the web browser may include Microsoft Internet Explorer, Apple Safari, Google Chrome, Opera, Mozilla Firefox, Lynx, and so forth.

At step 408, the processing module 208 provides the uniform resource locator (or the resource locator) to the one or more second users 108A-108N to enable the one or more second users 108A-108N to initiate the session for interaction with the one or more designated spreadsheet sections via the resource locator based on the at least one permission. The resource locator may include a link to a storage location, a uniform resource locator to a web page, an address of a network device, an address of a cloud based network storing the one or more designated spreadsheet sections.

Then at step 410, the display module 210 presents the one or more designated spreadsheet sections to the one or more second users 108A-108N on initiation of the session for interaction such that other spreadsheet sections are not visible to the one or more second users 108A-108N. The session for interaction may be initiated based on the selection of the resource locator by the one or more of the second users 108A-108N. The one or more designated spreadsheet sections may be displayed on the second computing devices 110A-110N of the second users 108A-108N, respectively based on the at least one permission allocated to the one or more second users 108A-108N. The one or more designated spreadsheet sections are displayed via at least one of an editable virtual layer and a non-editable virtual layer in the web browser on an associated second computing device of the one or more second users. In some embodiments, the one or more designated spreadsheet sections are displayed via the editable virtual layer when the at least one permission allocated to the one or more second users 108A-108N includes an editing permission. In some embodiments, the one or more designated spreadsheet sections are displayed via the editable virtual layer is displayed when the at least one permission allocated to the one or more second users 108A-108N includes only a view permission and no editing permission.

Thereafter at step 412, the processing module 208 enables the one or more second users 108A-108N to manipulate data of the one or more designated spreadsheet sections to obtain an output based on the data and calculations available on the one or more designated spreadsheet sections. In some embodiments, the processing module 208 is further configured to determine the output when the one or more second users 108A-108N with the allocated permissions manipulates the data in the one or more designated spreadsheet sections based on the data present in other sections of the spreadsheet in the form of calculations, charts, graphs, numbers, and so forth without altering any other section(s) of the spreadsheet.

In some embodiments, the one or more second users 108A-108N may save one or more changes done in the one or more designated spreadsheet sections including edited virtual layers at one or more second users' end respectively based on the at least one permission. The one or more second users' end may include a storage location of the second computing devices 110A-110N, respectively. In some embodiments, the one or more second users 108A-108N are allowed to save a copy of the one or more designated sections (edited or unedited) at their end.

In some embodiments, at least one of the one or more second users 108A-108N having special editing permission allocated by the first user 102 is allowed to modify the content of the one or more designated spreadsheet sections. The display module 210 may be configured to present the one or more designated spreadsheet sections including modified content in a single view to at least one of the first user 102 and other second users 108A-108N.

The present disclosure provides a spreadsheet managing system for secure and interactive layer based presentation of one or more sections of a spreadsheet.

The present disclosure provides a method for presenting one or more designated spreadsheet sections contained within a spreadsheet through a web interface without exposing other spreadsheet sections across a network service. The method includes preparing the designated spreadsheet sections to be presented across a network service by a first user, wherein the designated spreadsheet sections are selected from the spreadsheet located in a cloud network; providing the first user, a plurality of options to allocate a plurality of permissions to one or more second users on the network device to initiate a session for interaction with the designated spreadsheet section; providing one or more second users on the network with a resource locator to create a connection for initiating the session for interaction with the designated spreadsheet section; providing one or more second users on the network a means to interact with the designated spreadsheet section without exposing the other spreadsheet sections; and providing one or more second users on the network a means to manipulate data of the designated spreadsheet section to obtain the output based on the data and calculations available on the designated spreadsheet section or the other spreadsheet sections.

According to an aspect of the present disclosure, the calculation results obtained by interacting with the designated spreadsheet sections via web-layers are only visible to the user requesting those calculations.

According to an aspect of the present disclosure, providing the first user, a plurality of options to allocate a plurality of permissions means an administrator or owner of the spreadsheet will have an interface that enables an administrator to allocate different set of rights to different set of users for the designated spreadsheet sections.

The present disclosure provides methods and systems for secure and selective network-based presentation of spreadsheet sections of a spreadsheet to other users for interaction and manipulation. Further, editing of the spreadsheet sections can be done either at the central spreadsheet engine level i.e. the spreadsheet managing system (although a user having permission can add layers of assumptions or scenarios) for everyone to see, or within his (user's) contained virtual web layer where his changes can be seen and presented only by the users allowed to see that layer.

In some embodiments, the different set of users (e.g. the second users 108A-108N) can also allocate different set of rights to each of other users depending upon the extent of rights allocated to them.

According to another aspect of the present disclosure, providing one or more second users 108A-108N on the network 106 with the resource locator to create a connection for initiating the session for interaction with the designated spreadsheet section means that the first user 102 who allocates permissions for presentation shall provide a URL, or a Link or any other address of a storage location for the second users 108A-108N to access a virtual copy of the one or more designated spreadsheet sections in the form of a virtual layer, which can be accessed through a web browser on the respective second computing devices 110A-110N.

In some embodiments, any user irrespective of being an administrator can provide the resource locator. Any user may be a second user of the second users 108A-108N in the network 106 who have been allocated permissions for accessing the one or more designated spreadsheet sections.

According to an aspect of the present disclosure, the one or more second users 108A-108N on the network 106 are provided with a means to interact with the designated spreadsheet section without exposing the other spreadsheet sections. It means that the second users 108A-108N may be presented with virtual layers of the designated spreadsheet sections to view, edit, share, or input data based on the allocated permissions, without altering any other spreadsheet sections that have not been shared with the second users 108A-108N.

According to an aspect of the present disclosure, the one or more second users 108A-108N on the network 106 are provided with a means to manipulate data of the designated spreadsheet section to obtain the output based on the data and calculations available on the designated spreadsheet section or the other spreadsheet sections. It means that the second users 108A-108N when altering the contents of the presented one or more designated spreadsheet sections can visualize the output within the same or additional layer, which can be even based on other spreadsheet sections that are not presented to the one or more second users 108A-108N.

In some embodiments, the presentation of the one or more designated spreadsheet sections includes display of an editable or a non-editable virtual layer in a web browser without exposing other spreadsheet sections to the one or more second users 108A-108N

In some embodiments, the designated spreadsheet section is one or more section including at least one cell in the spreadsheet, a chart, a graph, or any other similar section of a spreadsheet.

In some embodiments of the present disclosure, the second users 108A-108N in the network 106 can optionally save the edited virtual layers at their end based on the at least one permission allocated to the one or more second users 108A-108N.

In some embodiments, the first user 102 can allocate permissions for the one or more second users 108A-108N in the network 106 for supplementary allocation of selective permissions to second users.

In some embodiments, the one or more designated spreadsheet sections may be paired with URL information that can be used to display the virtual layer in a web browser.

In some embodiments, the second users 108A-108N in the network 106 can manipulate the data in the one or more designated spreadsheet sections to determine a resultant output based on the data present in other sections of the spreadsheet in the form of calculations, charts, graphs, or the like without altering any section of the spreadsheet.

In some embodiments, some of the second users 108A-108N who are allocated with special editing permission can change the content of the designated spreadsheet section, which is stored and represented in a single view to the first user 102 or similar second users 108A-108N based on allocated permissions/rights.

An embodiment of the present disclosure provides a method for enabling a first user to selectively present one or more sections of a spreadsheet to one or more second users connected to a network. The method includes receiving a selection of one or more designated spreadsheet sections of the spreadsheet from the first user. The method further includes providing a plurality of permission options to the first user. The first user allocates at least one permission to the one or more second users for initiating a session for interaction with the one or more designated spreadsheet sections by selecting one or more of the plurality of permission options. The method furthermore includes providing a resource locator to the one or more second users to enable the one or more second users to initiate the session for interaction with the one or more designated spreadsheet sections via the resource locator based on the at least one permission. The method also includes enabling the one or more second users to manipulate data of the one or more designated spreadsheet sections to obtain an output based on the data and calculations available on the one or more designated spreadsheet sections.

According to an aspect of the present disclosure, the one or more designated spreadsheet sections are presented to the one or more second users on initiation of the session for interaction such that other spreadsheet sections are not visible to the one or more second users, wherein the one or more designated spreadsheet sections are displayed via at least one of an editable virtual layer and a non-editable virtual layer in a web browser on an associated second computing device of the one or more second users.

According to another aspect of the present disclosure, the method further includes enabling the one or more second users to save one or more changes done in the one or more designated spreadsheet sections comprising edited virtual layers at one or more second users' end respectively based on the at least one permission.

According to another aspect of the present disclosure, the method further includes associating the one or more designated spreadsheet sections with at least one uniform resource locator (URL) to be used to display a virtual layer in the web browser.

According to another aspect of the present disclosure, the method further includes determining the output when the one or more second users with the allocated permissions manipulates the data in the designated spreadsheet sections based on the data present in other sections of the spreadsheet in the form of calculations, charts, and graphs without altering any other section of the spreadsheet.

Another embodiment of the present disclosure provides a spreadsheet managing system for enabling a first user to selectively present one or more sections of a spreadsheet to one or more second users connected to a network. The spreadsheet managing system includes an input module configured to receive a selection of one or more designated spreadsheet sections of the spreadsheet from the first user. The spreadsheet managing system also includes a permission managing module configured to provide a plurality of permission options to the first user, wherein the first user allocates at least one permission to the one or more second users for initiating a session for interaction with the one or more designated spreadsheet sections by selecting one or more of the plurality of permission options. The spreadsheet managing system also includes a processing module configured to provide a resource locator to the one or more second users to enable the one or more second users to initiate the session for interaction with the one or more designated spreadsheet sections via the resource locator based on the at least one permission. The processing module is also configured to enable the one or more second users to manipulate data of the one or more designated spreadsheet sections to obtain an output based on the data and calculations available on the one or more designated spreadsheet sections.

According to an aspect of the present disclosure, the one or more designated spreadsheet sections comprises one or more sections selected from at least one of a chart, a graph, and at least one cell of the spreadsheet.

According to another aspect of the present disclosure, the spreadsheet managing system includes a display module configured to present the one or more designated spreadsheet sections to the one or more second users on initiation of the session for interaction such that other spreadsheet sections are not visible to the one or more second users, wherein the one or more designated spreadsheet sections are displayed via at least one of an editable virtual layer and a non-editable virtual layer in a web browser on an associated second computing device of the one or more second users.

According to another aspect of the present disclosure, the processing module is further configured to enable the one or more second users to save one or more changes done in the one or more designated spreadsheet sections comprising edited virtual layers at one or more second users' end respectively based on the at least one permission.

According to another aspect of the present disclosure, the processing module is further configured to associate the one or more designated spreadsheet sections with at least one uniform resource locator (URL) to be used to display a virtual layer in the web browser.

According to another aspect of the present disclosure, the processing module is further configured to determine the output when the one or more second users with the allocated permissions manipulates the data in the designated spreadsheet sections based on the data present in other sections of the spreadsheet in the form of calculations, charts, and graphs without altering any other section of the spreadsheet.

Yet another embodiment of the present disclosure provides a method for presenting at least one spreadsheet section contained within a spreadsheet through a web interface without exposing other spreadsheet sections. The method includes enabling, by an input module of a spreadsheet managing system, a first user to select and prepare one or more designated spreadsheet sections from the spreadsheet stored in a cloud network for sharing with one or more second users connected to a network, wherein the one or more designated spreadsheet sections comprises one or more sections selected from at least one of a chart, a graph, and at least one cell of the spreadsheet. The method also includes providing, by a permission managing module of the spreadsheet managing system, a plurality of permission options to the first user, wherein the first user allocates at least one permission to the one or more second users for initiating a session for interaction with the one or more designated spreadsheet sections by selecting one or more of the plurality of permission options. The method also includes associating, by the processing module, the one or more designated spreadsheet sections with at least one uniform resource locator (URL) to be used to display a virtual layer in a web browser. The method also includes providing, by the processing module, at least one uniform resource locator to the one or more second users to enable the one or more second users to initiate the session for interaction with the one or more designated spreadsheet sections based on the at least one permission. The method also includes presenting, by a display module of the spreadsheet managing system, the one or more designated spreadsheet sections to the one or more second users on initiation of the session for interaction such that other spreadsheet sections are not visible to the one or more second users, wherein the one or more designated spreadsheet sections are displayed via at least one of an editable virtual layer and a non-editable virtual layer in the web browser on an associated second computing device of the one or more second users. The method further includes enabling, by the processing module, the one or more second users to manipulate data of the one or more designated spreadsheet sections to obtain an output based on the data and calculations available on the one or more designated spreadsheet sections. Further, calculation output requested to the spreadsheet managing system (or a central spreadsheet engine) do not modify the spreadsheet and only appear in the virtual layers of the second user from which the calculation request has been made.

According to an aspect of the present disclosure, the first user is an administrator of the spreadsheet and the one or more designated spreadsheet sections.

According to another aspect of the present disclosure, the at least one permission allocated to the one or more second users comprises a permission for supplementary allocation of one or more permissions to at least one user.

According to another aspect of the present disclosure, at least one of the one or more second users having special editing permission allocated by the first user is allowed to modify the content of the one or more designated spreadsheet sections, wherein the display module presents the one or more designated spreadsheet sections comprising modified content in a single view to at least one of the first user and other second users.

According to an aspect of the present disclosure, the output is determined when the one or more second users with the allocated permissions manipulates the data in the designated spreadsheet sections based on the data present in other sections of the spreadsheet in the form of calculations, charts, and graphs without altering any other section of the spreadsheet.

The method described in the present disclosure includes preparing, by a first user, one or more designated spreadsheet section for presenting across a network. A plurality of options are provided to the first user to allocate a plurality of permissions to one or more second users connected to the network so that the one or more users can initiate a session for interaction with the designated spreadsheet section. The one or more second users are provided with a resource locator to create a connection for initiating the session for interaction with the one or more designated spreadsheet sections. Further, the one or more second users are provided with suitable means such as editing options to interact with the designated spreadsheet sections without exposing the other spreadsheet sections. Further, the one or more second users are provided with a means to manipulate data of the one or more designated spreadsheet sections to obtain the output based on the data and calculations available on the designated spreadsheet section and/or the other spreadsheet sections.

The present disclosure provides a method and system for secure presentation of designated spreadsheet section without exposing the other sections of the spreadsheet.

The present disclosure is directed towards providing a secure and customized presentation of designated spreadsheet sections, wherein the user can manipulate designated spreadsheet sections to view resultant output.

The present disclosure provides a method for presenting one or more designated spreadsheet sections in at least one of an editable or non-editable virtual layer in a web browser without exposing other spreadsheet sections to one or more second users connected through a network. Further, the one or more second users in the network can manipulate the data in the designated spreadsheet section to determine a resultant output based on the data present in other sections of the spreadsheet in the form of calculations, charts, graphs, or the like without altering any section of the spreadsheet.

The present disclosure also provides a system for presenting one or more designated spreadsheet sections in at least one of an editable or non-editable virtual layer in a web browser without exposing other spreadsheet sections to one or more second users connected through a network. Further, the one or more second users in the network can manipulate the data in the designated spreadsheet section to determine a resultant output based on the data present in other sections of the spreadsheet in the form of calculations, charts, graphs, or the like without altering any section of the spreadsheet.

According to an aspect of the present disclosure, the calculation output requested to the spreadsheet managing system or a central spreadsheet engine do not modify the spreadsheet or the spreadsheet sections, and the changes or manipulation may only appear in the virtual layers from which the calculation request has been made.

The methods and systems disclosed in the present disclosure enables a user (like a first user) to share one or more sections of a file with one or more other users without disclosing other parts of the file (spreadsheet) to the one or more users.

The methods and spreadsheet managing systems for presenting designated spreadsheet sections of a spreadsheet through a web interface without exposing other spreadsheet sections across a network service are provided. The methods and systems provide a secure layer-based presentation of spreadsheet sections for visualization and manipulation of data in designated spreadsheet sections to derive output from calculations based on data from other spreadsheet sections without exposing or altering other spreadsheet sections.

The present disclosure also provides a system to undertake the method disclosed in this disclosure in entirety or in parts as and where applicable.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A method for enabling a first user to selectively present and grant interaction with one or more sections of a spreadsheet to one or more second users connected to a network, comprising:
receiving a selection of one or more designated spreadsheet sections of the spreadsheet from the first user;
providing a plurality of permission options to the first user, wherein the first user allocates at least one permission to the one or more second users for initiating a session for interaction with the one or more designated spreadsheet sections by selecting one or more of the plurality of permission options;
providing a resource locator to the one or more second users to enable the one or more second users to initiate the session for interaction with the one or more designated spreadsheet sections via the resource locator based on the at least one permission; and
enabling the one or more second users to manipulate data of the one or more designated spreadsheet sections to obtain an output based on the data and calculations available on the one or more designated spreadsheet sections.

2. The method of claim 1, wherein the one or more designated spreadsheet sections comprises one or more sections selected from at least one of a chart, a graph, and at least one cell of the spreadsheet.

3. The method of claim 2 further comprising presenting the one or more designated spreadsheet sections to the one or more second users on initiation of the session for interaction such that other spreadsheet sections are not visible to the one or more second users, wherein the one or more designated spreadsheet sections are displayed via at least one of an editable virtual layer and a non-editable virtual layer in a web browser on an associated second computing device of the one or more second users.

4. The method of claim 3 further comprising enabling the one or more second users to save one or more changes done in the one or more designated spreadsheet sections comprising edited virtual layers at one or more second users' end respectively based on the at least one permission.

5. The method of claim 2, wherein the first user is an administrator of the spreadsheet and the one or more designated spreadsheet sections.

6. The method of claim 3, wherein the at least one permission allocated to the one or more second users comprises a permission for supplementary allocation of one or more permissions to at least one user.

7. The method of claim 6 further comprising associating the one or more designated spreadsheet sections with at least one uniform resource locator (URL) to be used to display a virtual layer in the web browser.

8. The method of claim 2 further comprising determining the output when the one or more second users with the allocated permissions manipulates the data in the designated spreadsheet sections based on the data present in other sections of the spreadsheet in the form of calculations, charts, and graphs without altering any other section of the spreadsheet, wherein the manipulations done in the one or more spreadsheet sections remain in the virtual layer and not transferred to the spreadsheet.

9. The method of claim 2, wherein at least one of the one or more second users having special editing permission allocated by the first user is allowed to modify the content of the one or more designated spreadsheet sections, wherein the one or more designated spreadsheet sections comprising modified content is presented in a single view to at least one of the first user and other second users based on the allocated at least one permission.

10. A spreadsheet managing system for enabling a first user to selectively present and/or grant interaction with one or more sections of a spreadsheet to one or more second users connected to a network, comprising:
an input module configured to receive a selection of one or more designated spreadsheet sections of the spreadsheet from the first user;
a permission managing module configured to provide a plurality of permission options to the first user, wherein the first user allocates at least one permission to the one or more second users for initiating a session for interaction with the one or more designated spreadsheet sections by selecting one or more of the plurality of permission options; and
a processing module configured to:
provide a resource locator to the one or more second users to enable the one or more second users to initiate the session for interaction with the one or more designated spreadsheet sections via the resource locator based on the at least one permission; and
enable the one or more second users to manipulate data of the one or more designated spreadsheet sections to obtain an output based on the data and calculations available on the one or more designated spreadsheet sections.

11. The spreadsheet managing system of claim 10, wherein the one or more designated spreadsheet sections comprises one or more sections selected from at least one of a chart, a graph, and at least one cell of the spreadsheet.

12. The spreadsheet managing system of claim 11 further comprising a display module configured to present the one or more designated spreadsheet sections to the one or more second users on initiation of the session for interaction such that other spreadsheet sections are not visible to the one or more second users, wherein the one or more designated spreadsheet sections are displayed via at least one of an editable virtual layer and a non-editable virtual layer in a web browser on an associated second computing device of the one or more second users.

13. The spreadsheet managing system of claim 12, wherein the processing module is further configured to enable the one or more second users to save one or more changes done in the one or more designated spreadsheet sections comprising edited virtual layers at one or more second users' end respectively based on the at least one permission.

14. The spreadsheet managing system of claim 11, wherein the first user is an administrator of the spreadsheet and the one or more designated spreadsheet sections.

15. The spreadsheet managing system of claim 12, wherein the at least one permission allocated to the one or more second users comprises a permission for supplementary allocation of one or more permissions to at least one user.

16. The spreadsheet managing system of claim 15, wherein the processing module is further configured to associate the one or more designated spreadsheet sections with at least one uniform resource locator (URL) to be used to display a virtual layer in the web browser.

17. The spreadsheet managing system of claim 11, wherein the processing module is further configured to determine the output when the one or more second users with the allocated permissions manipulates the data in the designated spreadsheet sections based on the data present in other sections of the spreadsheet in the form of calculations, charts, and graphs without altering any other section of the spreadsheet, wherein the manipulations done to the one or more spreadsheet sections remain in the virtual layer and not transferred to the spreadsheet.

18. The spreadsheet managing system of claim 11, wherein at least one of the one or more second users having special editing permission allocated by the first user is allowed to modify the content of the one or more designated spreadsheet sections, wherein the display module presents the one or more designated spreadsheet sections comprising modified content in a single view to at least one of the first user and other second users.

19. A method for presenting and/or granting interaction with at least one spreadsheet section contained within a spreadsheet through a web interface without exposing other spreadsheet sections, comprising:
enabling, by an input module of a spreadsheet managing system, a first user to select and prepare one or more designated spreadsheet sections from the spreadsheet for sharing with one or more second users connected to a network via a virtual layer, wherein the one or more designated spreadsheet sections comprise one or more sections selected from at least one of a chart, a graph, and at least one cell of the spreadsheet;
providing, by a permission managing module of the spreadsheet managing system, a plurality of permission options to the first user, wherein the first user allocates at least one permission to the one or more second users for initiating a session for interaction with the one or more designated spreadsheet sections by selecting one or more of the plurality of permission options;
associating, by the processing module, the one or more designated spreadsheet sections with at least one uniform resource locator (URL) to be used to display a virtual layer in a web browser;
providing, by the processing module, at least one uniform resource locator to the one or more second users to enable the one or more second users to initiate the session for interaction with the one or more designated spreadsheet sections based on the at least one permission;
presenting, by a display module of the spreadsheet managing system, the one or more designated spreadsheet sections to the one or more second users on initiation of the session for interaction such that other spreadsheet sections are not visible to the one or more second users, wherein the one or more designated spreadsheet sections are displayed via at least one of an editable virtual layer and a non-editable virtual layer in the web browser on an associated second computing device of the one or more second users; and
enabling, by the processing module, the one or more second users to manipulate data of the one or more designated spreadsheet sections to obtain an output based on the data and calculations available on the one or more designated spreadsheet sections, wherein calculation output requested to the spreadsheet managing system do not modify the spreadsheet and only appear in the virtual layers from which the calculation request has been made.

20. The method of claim 19 further comprising:
determining, by the processing module, the output when the one or more second users with the allocated permissions manipulates the data in the designated spreadsheet sections based on the data present in other sections of the spreadsheet in the form of calculations, charts, and graphs without altering any other section of the spreadsheet, wherein the at least one of the one or more second users having special editing permission allocated by the first user is allowed to modify the content of the one or more designated spreadsheet sections; and
presenting, by the display module, the one or more designated spreadsheet sections comprising modified content in a single view to at least one of the first user and other second users based on the allocated at least one permission.
